(19) United States
(12) Patent Application Publication
(10) Pub. No.: US 2018/0221744 A1
(43) Pub. Date: Aug. 9, 2018

(54) Pivotable Coupling Assembly with Lateral Flexure

(71) Applicant: Joshua Ball, Hickory, NC (US)

(72) Inventor: Joshua Ball, Hickory, NC (US)

(21) Appl. No.: 15/428,291

(22) Filed: Feb. 9, 2017

(51) Int. Cl. A63B 69/18; A63C 5/03; F16M 11/10

(52) U.S. Cl. CPC A63B 69/18; F16M 11/10; A63C 5/03

(57) ABSTRACT

A pivotable coupling assembly having lateral flexure and apparatuses utilizing the pivotable coupling assembly. The pivotable coupling assembly includes a link that is adjustably connected to a first member, such as a board, and a yoke that is connected to a second member, such as a base. The yoke is configured to pivotably receive the link, allowing the first member to pivot longitudinally relative to the second member. The link is fabricated from a material having sufficient stiffness to support the weight of a board and a rider, while also having sufficient flexure to allow the link to bend laterally when stressed. The pivotable coupling assembly thereby allows the first member to rotate or bend laterally, while still permitting longitudinal movement thereof. The bidirectional movement provided by the coupling assembly mimics the movement or control of a board, such as a snowboard, under normal conditions when snowboarding.

### BACKGROUND OF THE INVENTION

The present invention relates to pivotable coupling assemblies. More specifically, the present invention relates to pivotable couple assemblies that are configured to provide bidirectional, i.e. both longitudinal and lateral, movement between two coupled components.

It can be difficult for beginner snowboarders to control their body movements while strapped into a snowboard, making it especially troublesome to exit a chairlift. Even advanced and professional snowboarders must refine and improve their technique to r raster their craft. Snowboarders require a specific amount of balance and riders need to know how to shift their weight along different points of the device. Therefore, there exists a need for a device that can assist both novice and seasoned snowboarders to train for snowboarding.

### SUMMARY OF THE INVENTION

In view of the disadvantages inherent in the known types of board training apparatuses now present in the prior art, the present invention provides a pivotable coupling assembly that is configured to both pivot longitudinally and flex laterally, thereby improving devices used for training for snowboarding, skateboarding, wakeboarding, and other such board or board-related sports. The present invention comprises a pivotable coupling assembly having lateral flexure and apparatuses utilizing the pivotable coupling assembly. The pivotable coupling assembly includes a link that is adjustably connected to a first member, such as a board, and a yoke that is connected to a second member, such as a base. The yoke is configured to pivotably receive the link, allowing the first member to pivot longitudinally relative to the second member. The link is fabricated from a material having sufficient stiffness to support the weight of a board and a rider, while also having sufficient flexure to allow the link to bend laterally when stressed. The pivotable coupling assembly thereby allows the first member to rotate or bend laterally, while still permitting longitudinal movement thereof. The bidirectional movement provided by the coupling assembly mimics the movement or control of a board, such as a snowboard, under normal conditions when snowboarding.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a first embodiment of the present coupling assembly as utilized in a snowboard training apparatus.

FIG. 2 shows an exploded perspective view of first embodiment of the coupling assembly as utilized in a snowboard training apparatus.

FIG. 3 shows an exploded view of a first embodiment of the coupling assembly.

FIG. 4 shows a front view of a first embodiment of the coupling assembly in an alternate configuration.

FIG. 5 shows a front view of a first embodiment of the coupling assembly.

FIG. 6 shows a perspective view of a second embodiment of the coupling assembly as utilized in a skateboarding training apparatus.

FIG. 7 shows a perspective view of a carrying accessory disposed around a first embodiment of the coupling assembly.

### DETAILED DESCRIPTION OF THE INVENTION

Reference is made herein to the attached drawings. Like reference numerals are used throughout the drawings to depict like or similar elements of the pivotable coupling assembly with lateral flexure. The figures are intended for representative purposes only and should not be considered to be limiting in any respect.

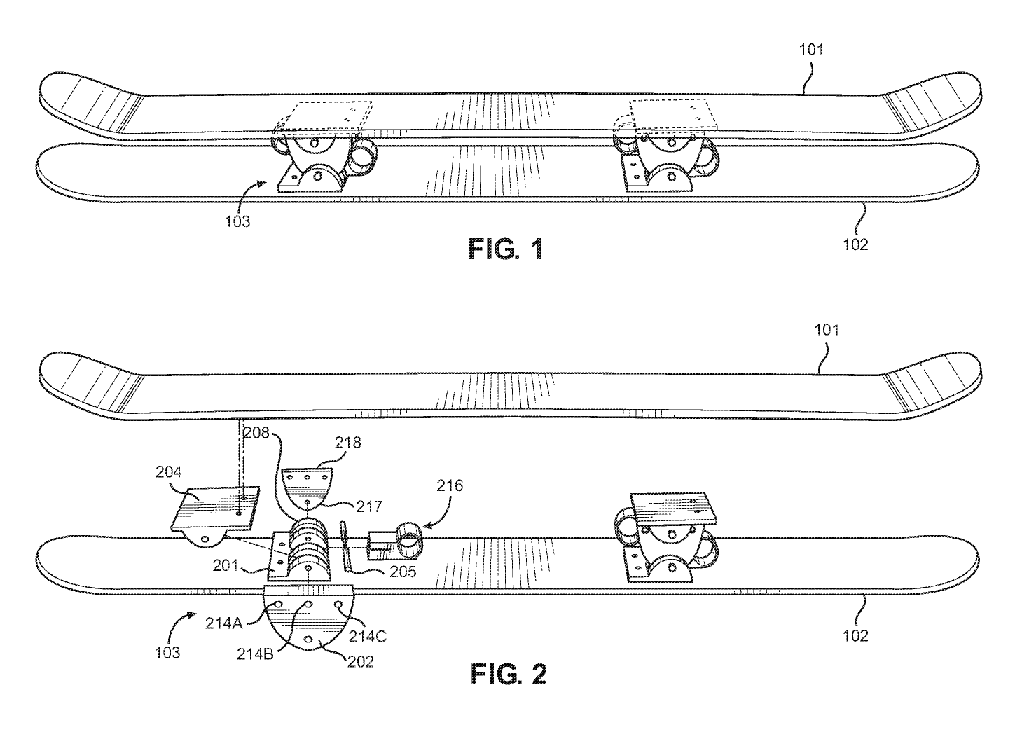

Referring now to FIG. 1, there is shown a perspective view of an embodiment of the coupling assembly as utilized in a snowboard training apparatus. The present coupling assembly is demonstrated in use as with a snowboard training apparatus in order to provide context; however, it should not be interpreted as limiting in any way. The present coupling assembly is configured for use with a training apparatus for any type of board sport, e.g. wakeboarding and skateboarding, and may additionally be incorporated into an apparatus configured for actual use in the field, rather than simply training.

The depicted snowboard training apparatus includes a board 101 connected to a base 102 via at least one pivotable coupling 103. The board 101 has the shape and configuration of a conventional snowboard. In one embodiment, the base 102 has a planar bottom surface that allows the apparatus to rest flat against a support surface when in use. In alternative embodiments, the board 101 is a skateboard deck, a wakeboard, or any other such device utilized in board sports. In one embodiment, the board 101 further includes bindings configured to engage snowboard boots, integrated boots configured to receive and bind the feet of a wearer as in a wakeboard, or other such supports. Alternatively, the board 101 lacks any bindings thereon.

In alternative embodiments, the base 102 is itself a second board, e.g. snowboard or skateboard deck. In these embodiments of apparatuses using the present pivotably coupling assembly, the base 102 and the board 101 are arranged in a stacked configuration wherein the user controls the movement of the apparatus by manipulating the board 101, which in turn controls the movement of the base 102 relative thereto. This configuration wherein the base 102 is a second board can be utilized in all types of board sport applications.

The pivotable coupling 103 is configured to pivot in a longitudinal direction and flex or bend in a lateral direction. The longitudinal direction is measured from a first end of the board to the second end of the board, wherein the lateral direction is perpendicular thereto. In embodiments of apparatuses configured to be utilized as training apparatus for conventional boards, the pivotable coupling 103 mimics the movement commonly associated with different types of board sports in order to allow users to practice balancing and other techniques utilized when partaking in these sports on a training apparatus. In embodiments of apparatuses configured to be utilized in the field during sporting applications, the pivotable coupling 103 allows for indirect control of the underlying base 102 via manipulation of the board 101, while still providing the board 101 with properties that mimic the feeling of directly controlling such a snowboard, skateboard, wakeboard, or other such sports board apparatus. Additionally, in alternative embodiments of apparatuses utilizing the present pivotable coupling assembly, the board 101 is a first type of board, e.g. a skateboard deck, and the base 102 is a second type of board, e.g. a wakeboard. This allows users to modify the base type of board with another type of board that the user ay be more familiar with or may simply prefer, while still allowing them to undertake the activity for which the base type of board was designed.

Referring now to FIG. 2, there is shown an exploded perspective view of an embodiment of the coupling assembly as utilized in a snowboard training apparatus. Each pivotable coupling 103 includes a first yoke 201 and a second yoke 204, wherein the first yoke 201 is disposed on the upper surface of the base 102 that is configured to engage the lower end 217 of a link 202 disposed on the lower surface of the board 101. The upper end 218 of each link 202 is secured to the undersurface of the board 101 via the second yoke 204. In the illustrated embodiment, each yoke 201, 204 includes at least one groove 208. In the illustrated embodiment, each yoke 201, 204 comprises a pair of grooves 208 that are configured to receive a pair of links 202 therein. Each groove 208 is configured to receive a single link 202. The link 202 is joined to the yokes 201, 204 via fasteners 205 extending through apertures disposed in the links 202 and grooves 208. A groove 208 has a width approximately equal to the width of a link 202, thereby restricting the link 202 from laterally reciprocating along the fastener 205 within the groove 208 when the link 202 is engaged with the yoke 201, 204. The angle at which the link 202 can pivot about a vertical axis is restricted by a pair of restrictors 216 that are positioned centrally between the yokes 201, 204. The lower restrictor 216 is secured to the first yoke 201 and the links 202 by a lower fastener 205 and the upper restrictor 216 is secured to the second yoke 204 and links 202 by an upper fastener. Further, the restrictors 216 are configured to prevent the fasteners 205 from disengaging from the links 202.

The upper end of each link 202 is securable to the second yoke 204 in one of multiple different positions, e.g. a posterior position relative to the second yoke 204, a neutral position relative to the second yoke 204, and an anterior position relative to the second yoke 204. In an illustrative embodiment of the pivotable coupling assembly 103, the link 202 includes a plurality of apertures 214A, 214B, 214C extending along its first end 218. When the link 202 is joined to the second yoke 204 via a fastener 205 through a first aperture 214A, the link 202 is positioned posteriorly relative to the second yoke 204. When the link 202 is joined to the second yoke 204 via a fastener 205 through a second aperture 214B, the link 202 is positioned neutrally relative to the second yoke 204. When the link 202 is joined to the second yoke 204 via a fastener 205 through a third aperture 214C, the link 202 is positioned anteriorly relative to the second yoke 204. The adjustable coupling of the link 202 to the yoke 201 allows users to adjust the properties.

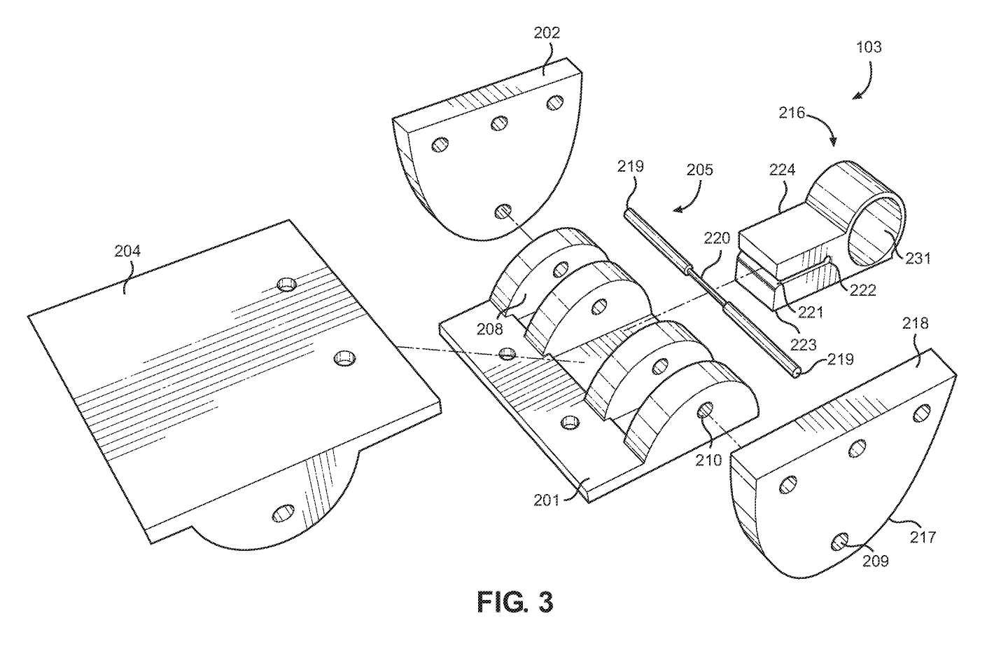

Referring now to FIG. 3, there is shown of an exploded view of a first embodiment of the coupling assembly. The links 202 are joined to the yoke 201 via the fastener 205 extending through aligned apertures disposed in the link 202 and each side of the groove 208. In the illustrated embodiment, the fastener 205 is an elongated pin having a pair of distal ends 219 and a central portion 220 disposed therebetween. In the illustrated embodiment, the central portion 220 comprises a diameter that is smaller than the diameter at the distal ends 219.

In one embodiment, the width of the link 202 tapers from the upper end 218 to a rounded lower end 217. This tapered, rounded second end 213 allows the link 202 to rotate within the groove 208 along the longitudinal axis thereof until the restrictor 216 contacts a second restrictor 216 or the lower face of the board 101. The lower end 217 further includes an aperture 209 thereon. The aperture 209 of the link 202 is positioned so as to align with a corresponding aperture 210 disposed on the first yoke 201 when the link 202 is engaged with the yoke 201. A fastener 205, such as a pin in the depicted embodiment of the snowboard training apparatus, can then be inserted through the aligned set of apertures 209, 210 to pivotably couple the link 202 to the yoke 201 about the fastener 205. When pivotably coupled, the board 101 is able to pivot longitudinally relative to the base 102. The degree of rotation of the board 101 relative to the base 102 is determined by the length of the groove 208.

Each restrictor 216 comprises a slot 221 configured to receive the central portion 220 of the fastener 205. The slot 221 extends from the lateral sides of the restrictor 216 and comprises a width that is slightly smaller than the diameter of the central portion 220. The width of the restrictor 216 is measured from the lower side 223 to the upper side 224 thereof. In this way, force is required to secure the restrictor 216 to the fastener 205. The slot 221 is adapted to open wider as the central portion 220 is forced from the distal end of the slot 221 to the proximal end. The proximal end of the slot 221 comprises a notch 222 that receives the central portion 220 of the fastener 205 therein. In the illustrated embodiment, the notch comprises a circle shaped cross-section. When the central portion 220 is disposed within the notch 222, the slot 221 returns to its natural or biased position and the fastener 205 is secured within the restrictor 216 until force is applied to open the slot 221 to a wider orientation. The end of the restrictor 216, opposing the distal end of the slot 221, comprises a ring 231 configured to receive a finger therethrough. The ring 231 assists the user when applying force to secure and unsecure the restrictor 216 to the fastener 205.

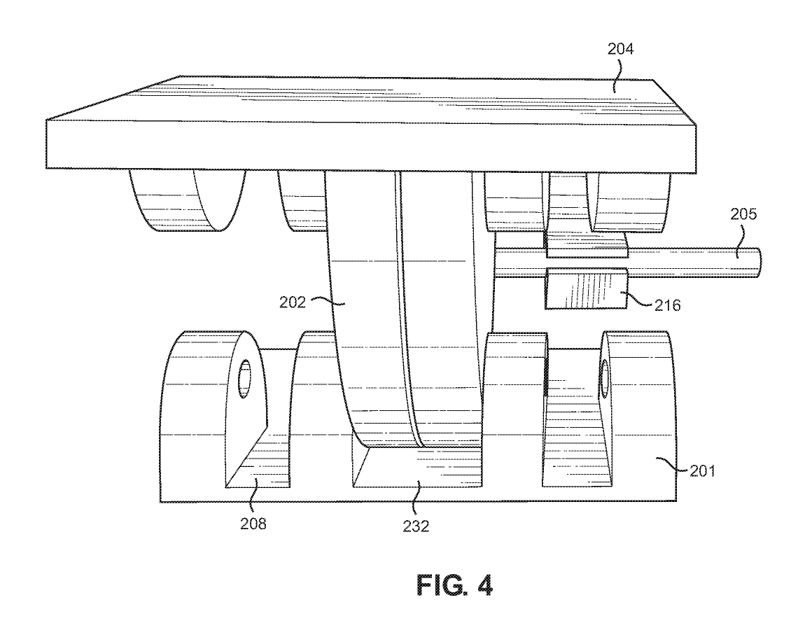

Referring now to FIG. 4, there is shown a front view of a first embodiment of the coupling assembly in an alternate configuration. In an alternate configuration of the coupling assembly, the links 202 are disposable within a central groove 232 of each yoke 201, 204. The central groove 232 is dimensioned to receive a pair of links 202 in a side-by-side orientation. The grooves 208 positioned on opposing sides of the central groove 232 are each configured to receive a single link 202 therein. The links 202 rest flush against the sides of the grooves 208, 232 when positioned therein. A distal end of a fastener 205 is positioned through apertures within links 202. A restrictor 216 receives the central portion of the fastener 205 therein. This positioning of the links 202 within the central groove 232 allows the board more lateral movement relative to when the links are positioned within the outer most grooves 208.

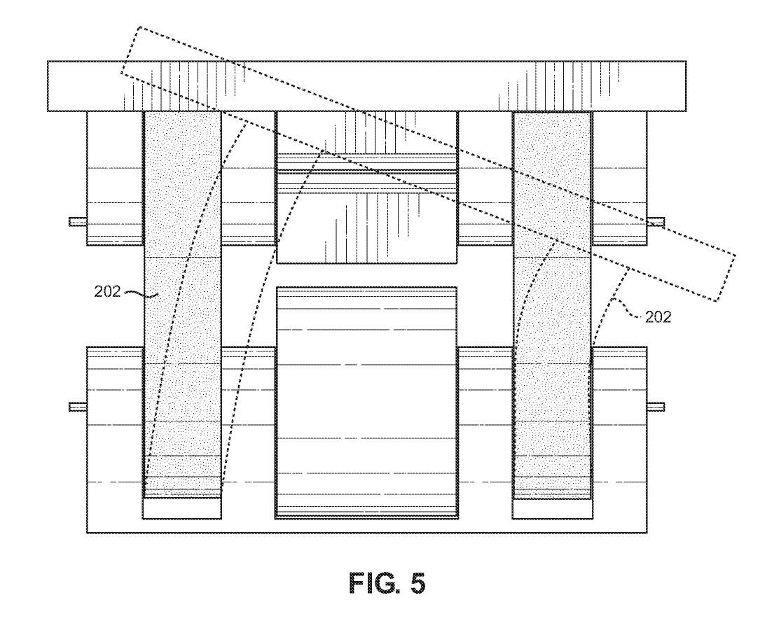

Referring now to FIG. 5, there is shown the front view of the first embodiment of the coupling mechanism. The links 202 are fabricated from a material that has sufficient stiffness to support the weight of the board and a rider thereon, but sufficient flexure to allow the link 202 to bend or deform laterally when subjected to the force of a rider manipulating the board 101. The ability of the link 202 to bend under sufficient stress, but then elastically return to its set position when the stressing force is removed allows an apparatus utilizing the present pivotable coupling assembly to mimic the movement and control of a conventional board, e.g. a snowboard. In one embodiment, the links 202 are fabricated from urethane 60D. In another embodiment, the links 202 are fabricated from urethane 75D. The links 202 may be constructed via injection molding of any such process. In another embodiment, the links 202 are fabricated from a material that maintains the aforementioned stiffness and elasticity properties at sub-freezing temperatures and/or while exposed or submerged in water so that the links 202 are suitable for use in snowboarding, wakeboarding or other such applications.

In the illustrated embodiment, the resting state of the link 202 is in an upright, linear orientation. When lateral force is applied to the link 202 via the tipping or manipulation of the board, the upper end of the link 202 bends or flexes along the same side as the board movement. The second restrictor 216 moves along with the board and upper end of the link 202. When the second restrictor 216 contacts the first restrictor 216, the link 202 is prevented from further lateral movement toward the base.

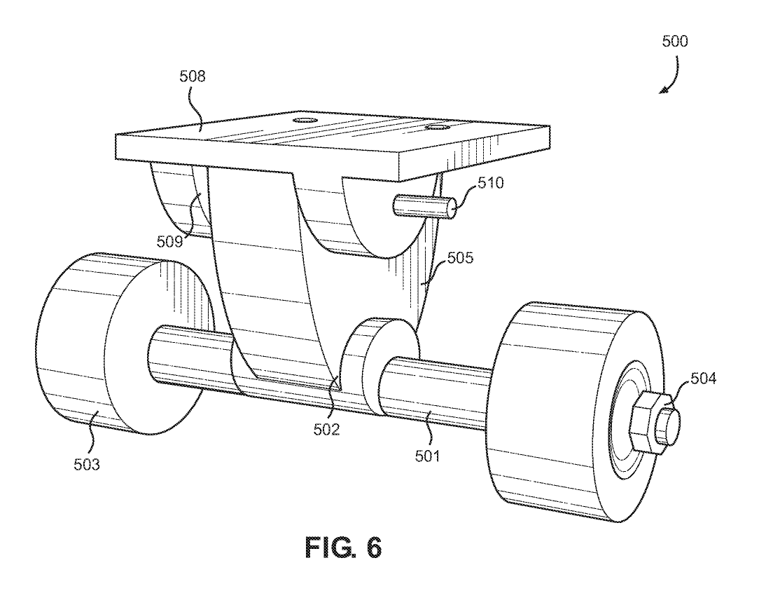

Referring now to FIG. 6 there is shown a second embodiment of the coupling assembly as utilized in a skateboarding training apparatus. In a second embodiment, the coupling assembly comprises 500 a first yoke 501 having a groove 502 centrally disposed thereon. The first yoke 501 is secured to a pair of wheels 503 via a fastening mechanism 504, wherein the wheels 503 are positioned on the distal ends of the first yoke 501. A lower end of a link 505 is disposed within the groove 502, wherein an upper end of the link 505 is secured to a second yoke 508 having a central groove 509. The upper end of the link 505 comprises an aperture that is aligned with an aperture disposed on each side of the central groove 509 of the second yoke 508. A fastener 510 is disposed through the apertures in order to secure the link to the second yoke 508. The second yoke 508 is securable to an underside of a board, such as a skateboard.

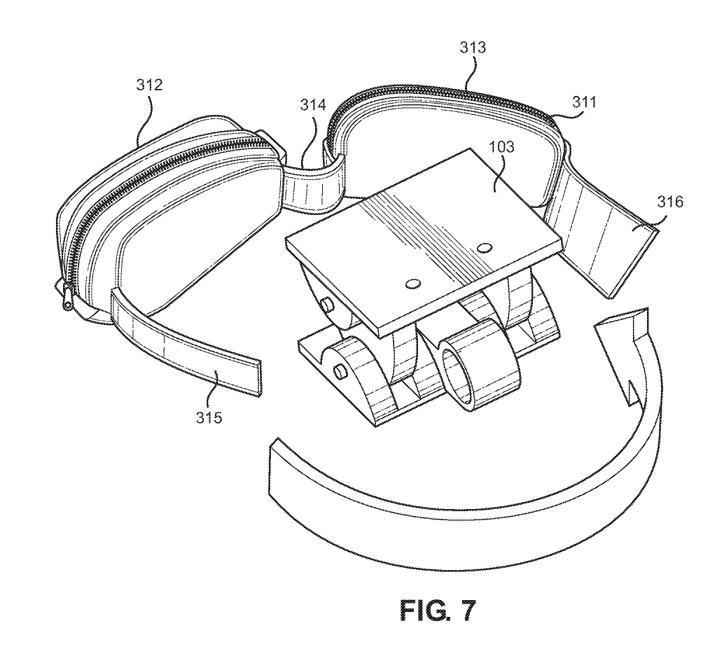

Referring now to FIG. 7, there is shown a perspective view of a carrying accessory disposed around a first embodiment of the coupling assembly. In some embodiments, the present invention comprises a carrying accessory 311 adapted to secured to the coupling assembly 103. The carrying accessory 311 comprises at least a pair of pouches, wherein a first pouch 312 is adapted to rest along a first lateral side of the coupling assembly 103 and a second pouch 313 is adapted to rest along a second lateral side of the coupling assembly 103. Each pouch 312, 313 is adapted to hold personal items therein. A first strap 314 permanently connects adjacent ends of the pouches 312, 313 to one another, wherein the first strap 314 is adapted to wrap around a front end of the coupling assembly 103. A pair of second straps 315, 316, each extending from opposing sides of the pouches 312, 313, are configured to fasten to one another, such that the carrying accessory forms a loop around the coupling assembly 103. In some embodiments, a leash is rotatably secured to the board via a ball bearing so as to allow a user to secure the board to his or her person via the leash.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A coupling assembly, comprising:
a first yoke and a second yoke, wherein each yoke comprises at least one groove;
the first yoke securable to an underside of a board and the second yoke securable to a base, such that the board and base are disposed in a stacked configuration;
a link having a lower end disposable within a groove of the first yoke and an upperend disposable within a groove of the second yoke;
the link configured to flex laterally under a pressure and return to an upright position after relief from the pressure;
the link configured to rotate within the groove of the first yoke along the longitudinal axis thereof;
a first fastener extending through the link;
a first restrictor having a slot, wherein the slot is configured to receive the first fastener therethrough.

2) The coupling assembly of claim 1, further comprising:
a second fastener extending through the second yoke and the link;
a second restrictor having a slot, wherein the slot is configured to receive the second fastener therethrough;
wherein the first restrictor and the second restrictor are disposed on opposing sides of the first and second yoke when in a stacked configuration.

3) The coupling assembly of claim 1, wherein the first fastener comprises a pair of opposing distal ends and a central portion, wherein the distal ends comprise a larger diameter than the diameter of the central portion.

4) The coupling assembly of claim 1, wherein the first restrictor comprises a notch disposed at a proximal end of the slot, wherein the notch receives the first fastener therein.

5) The coupling assembly of claim 1, wherein the first restrictor comprises a ring disposed on an opposing side of the slot, wherein the ring is configured to receive a finger therethrough.

6) The coupling assembly of claim 1, further comprising a base secured to the first yoke and a board secured to the second yoke.

7) The coupling assembly of claim 1, wherein the lower end of the link is rounded and taper from the upper end to the lower end.

8) The coupling assembly of claim 1, wherein the upper end of the link comprises a plurality of apertures disposed in a row.

9) The coupling assembly of claim 1, wherein the groove is disposed in the center of the first and second yokes and configured to receive a pair of links therein.

10) The coupling assembly of claim 9, further comprising a pair of grooves disposed on opposing sides of the groove positioned therebetween, wherein each of the pair of grooves is dimensioned to receive a single link.

11) The coupling assembly of claim 2, the second restrictor is configured to contact the first restrictor as the link bends laterally.

12) The coupling assembly of claim 1, wherein the first yoke comprises a pair of wheels disposed on the distal ends thereof.

13) The coupling assembly of claim 1, further comprising a carrying accessory having pair of pouches configured to secure to the coupling assembly, forming a loop configuration therearound.
